(19) United States
(12) Patent Application Publication
(10) Pub. No.: US 2013/0146045 A1
(43) Pub. Date: Jun. 13, 2013

(54) Device for heating and/or cooking food

(71) Applicant: Jean-Paul VULLIERMET, Agde (FR)

(72) Inventor: Jean-Paul VULLIERMET, Agde (FR)

(73) Assignee: Beaba, Paris (FR)

(21) Appl. No.: 13/493,053

(22) Filed: Jun. 11, 2012

(30) Foreign Application Priority Data
Jun. 10, 2011 (FR) 1155136

(51) Int. Cl. A47J 27/08

(52) U.S. Cl. CPC A47J 27/0804
USPC 126/369.2; 126/369; 99/337; 220/316

(57) ABSTRACT

A device for heating and/or cooking food, and especially baby food, including:
at least one steam generator, comprising a bowl capable of receiving water, intended to turn water into steam for heating or cooking the food;
at least one cooking and/or heating container, communicating with said steam generator, and receiving a removable cooking basket, capable of receiving the food to be heated and/or to be cooked;
at least one closing means capable of closing the cooking and/or heating container, said means also simultaneously and reversibly closing the cooking and/or heating container and the steam generator bowl.

### CROSS-REFERENCE TO RELATED APPLICATIONS

The present application claims priority under 35 U.S.C. §119 to French Patent Application No. 1155136 (filed on Jun. 10, 2011), which is hereby incorporated by reference in its entirety.

### FIELD OF THE INVENTION

The present disclosure relates to a device intended to enable to heat and/or to cook food. More specifically, the present disclosure relates to such a device for the cooking of baby food.

### BACKGROUND OF THE INVENTION

It is well known to homogeneously heat baby food by means of an adapted device, with or without simultaneously or subsequently mixing said food, while further simplifying the subsequent phase of washing and cleaning of the container receiving the food.

Such a device has for example been described in document FR 2 774 274. It is basically comprised of a steam generator, intended to produce steam for heating or cooking the food; and a cooking container, receiving a removable cooking basket provided with through openings, intended to allow the passage of steam, said container being reversibly closed at its upper end by means of a removable cover.

In accordance with the teachings of this document: the removable cover is provided with a through opening, intended to enable the steam generator to communicate with the inside of said container, and especially of the cooking basket; the through openings of the cooking basket are formed close to its base; and the container is provided with a through opening substantially formed close to the upper end of the wall defining it.

Such a device enables to achieve a homogeneous heating and cooking of baby food, without requiring a mixing phase when this is not required besides.

Such a device is fully satisfactory in terms of homogeneous cooking of the food, but has a few practical disadvantages, which are provided to be solved by the present invention.

### SUMMARY OF THE INVENTION

One of the issues addressed by the present invention is the simplification of the design of the device, especially in terms of manufacturing. Thus, the present invention provides a simultaneous opening of the bowl of the steam generator and of the container receiving the removable cooking basket. Thereby, the user can simultaneously access the bowl and the container with one hand. The other hand may for example be used to carry a child.

Another issue addressed by the present invention is to enable to separately cook different ingredients, such as meat and vegetables, for example.

The present invention thus aims at providing a device for heating and/or cooking food, which overcomes the above-mentioned disadvantages by providing an advantageous use as compared with prior art solutions.

To solve the above-mentioned issues, a device for heating and/or cooking food, and especially baby food, has been developed, which comprises: at least one steam generator, comprising a bowl capable of receiving water, intended to turn water into steam for heating or cooking the food; at least one cooking and/or heating container, communicating with said steam generator, and receiving a removable cooking basket; and at least one closing means capable of closing the cooking and/or heating container.

In accordance with the present invention, the closing means also simultaneously and reversibly close the cooking and/or heating container and the bowl of the steam generator.

Thereby, the bowl and the container can be simultaneously accessed with one hand.

In accordance with an embodiment of the present invention, to enable to pass from a closed position to a non-closed position, the closing means comprise a cover attached to an arm articulated with respect to the frame of the device.

And, in closed position, the cooking and/or heating container is closed by the cover, and the steam generator bowl is closed by the arm.

Advantageously, the cover is removably connected to the arm. This enables to he able to remove the container while keeping the cover removably attached thereto.

To enable the steam generator to communicate with the inside of the container, and especially of the cooking container, the cover is provided with a through opening.

Preferably, the closing means comprise elements enabling to lock it in closed position and to unlock it. This enables, by actuating said elements, to simultaneously open the bowl and the container.

In accordance with an embodiment of the present invention, to enable the separate cooking of different ingredients, such as meat and vegetable, the device comprises: two steam generators, arranged in a same housing, dedicated to the production of steam; two cooking containers, arranged on either side of the steam generators and in communication therewith; and two closing means simultaneously and reversibly closing the cooking and/or heating containers and the corresponding steam generator bowls.

### BRIEF DESCRIPTION OF THE DRAWINGS

The foregoing and other features and advantages of the present invention will be discussed in detail in the following non-limiting description of two preferred embodiments in connection with accompanying drawings.

FIG. 1 is a simplified view showing the device for heating and/or cooking baby food in accordance with the present invention in its two-container version, in front view.

FIG. 2 is a simplified exploded view of the device of FIG. 1.

FIG. 3 is a simplified view similar to FIG. 1, this time in top view.

FIG. 4 is a simplified cross-section view along axis A-A shown in FIG. 3.

FIG. 5 is a simplified cross-section view along axis B-B shown in FIG. 4.

FIG. 6 is a simplified cross-section view along axis C-C shown in FIG. 4.

FIG. 7 is a simplified top and bottom perspective view of the articulated arm.

FIG. 8 is a simplified exploded view of the articulated arm.

FIG. 9 is a simplified cross-section view along the length of the articulated arm.

FIG. 10 is a simplified perspective view of the device of the present invention in one-container or solo mode.

### DETAILED DESCRIPTION OF EMBODIMENTS

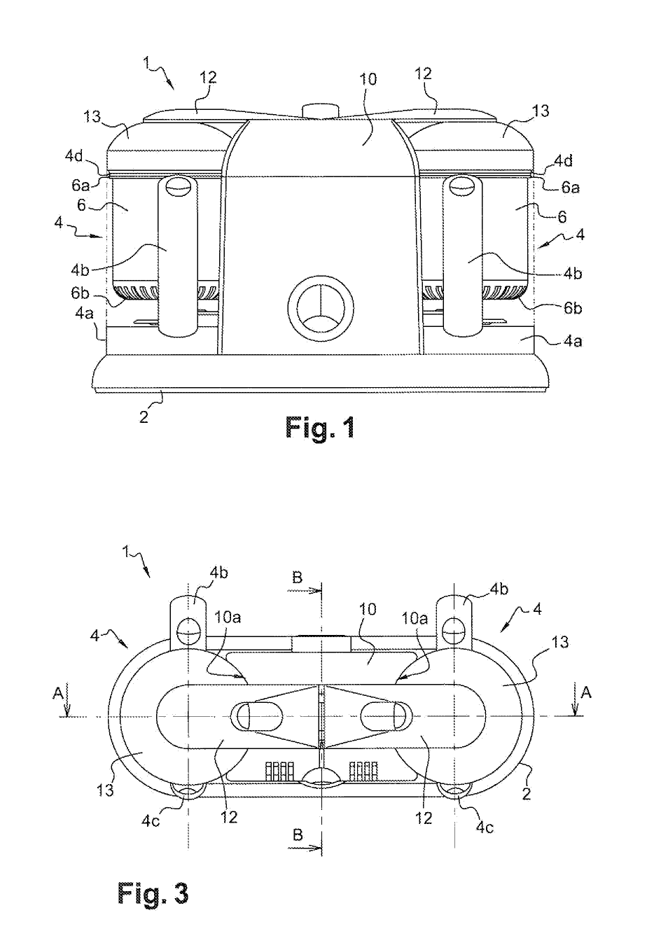

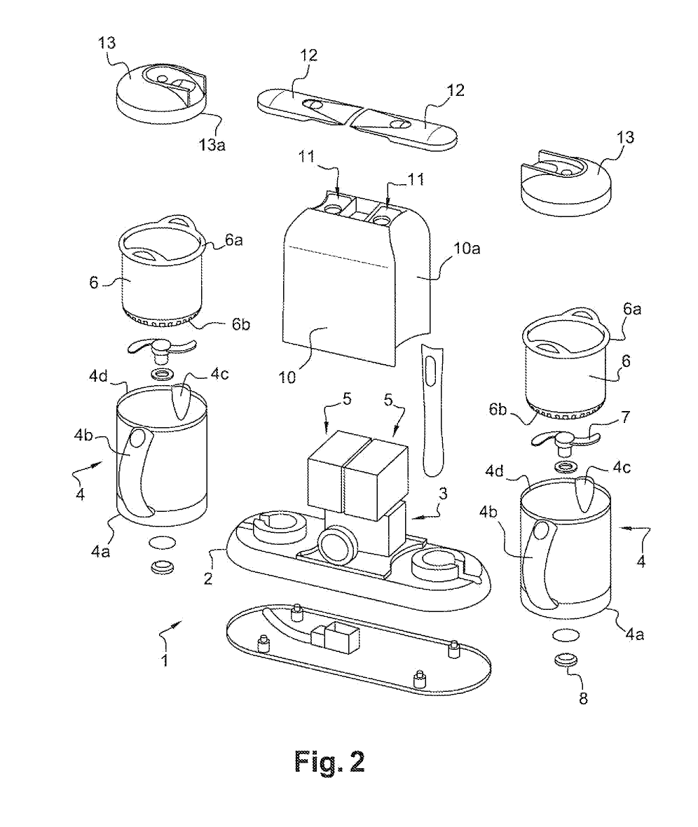

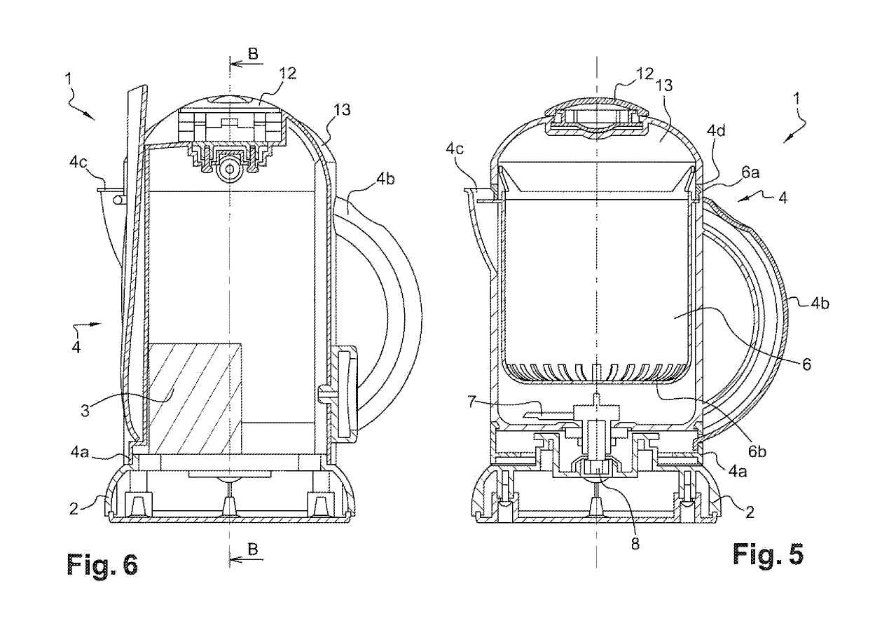

Referring to FIGS. 1 to 6, the device (1) in accordance with the present invention is shown in “two-container” mode, that is, it comprises two bowls or containers, each associated with a steam generator, as will be described in further detail hereinafter.

It basically comprises an oblong seat (2) supporting a housing (10) receiving two steam generators (3) and two containers (4), each intended to receive a removable cooking basket (6), said containers being located on either side of the housing (10).

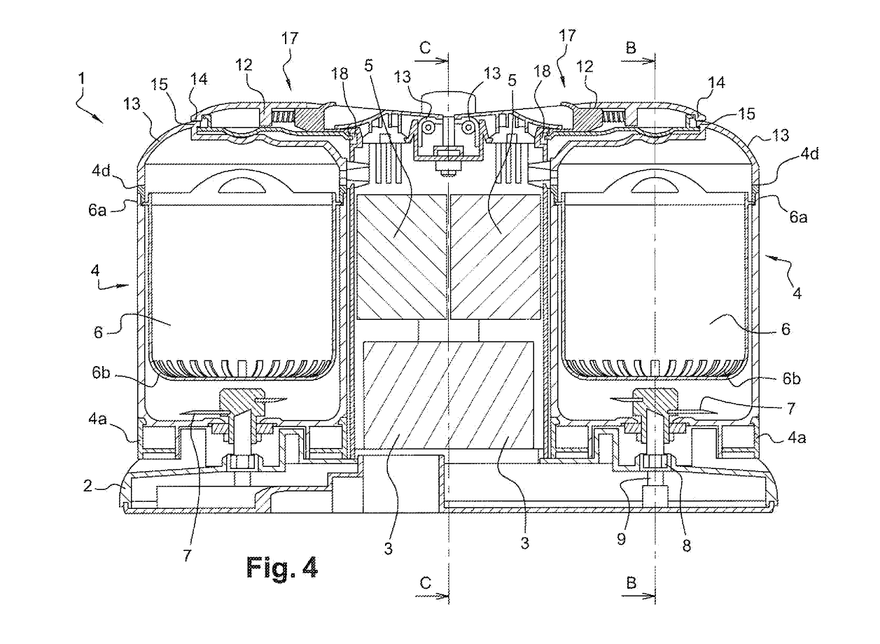

As can be seen in FIG. 4, the two steam generators (3) are arranged side by side substantially at the center of the seat (2). They each comprise a bowl (5), intended to receive the water necessary for the production of steam, and a heat source, typically formed by ring-shaped electric resistors (not shown) placed under said bowls (5).

The two containers (4) are arranged on either side of said steam generators (3), at the ends of the oblong seat (2). The two containers (4) are identical and are typically made of transparent polysulphone. They could however be made of copolyester, or again of polyamide. They have a symmetry of revolution, especially cylindrical. They comprise a base (4a) with which they bear on the seat (2) of the device (1) in accordance with the present invention. Such containers (4) also comprise a grasping handle (4b) and a spout (4c), diametrically opposite to the grasping handle (4b).

The containers (4) are intended to receive a removable cooking basket (6), the latter bearing by an upper peripheral ring-shaped protrusion (6a) on a shoulder (4d) formed for this purpose within the lateral internal wall defining the container (4).

This basket (6) is provided with a number of through openings (6b), all formed at the level of its seat. Such through openings (6b) are typically formed of eyes extending between the bottom and the base of the lateral wall defining said basket (6). They are uniformly spaced and distributed. The through openings may also comprise circular ports, formed at the bottom of said basket (6).

The container (4) may also be provided with a mixing knife (7), rotated via a nut (8) meshing on a drive shaft (9), itself activated by an electric motor, advantageously located under one of the containers (4).

The housing (10) covers the two steam generators (3). The housing (10) has a generally rectangular shape and comprises lateral cylindrical recesses (10a) to follow the shape of the two containers (4). Openings (11) are made on its upper portion to provide access to the bowls (5) receiving the water necessary for the steam generation.

In accordance with the present invention, an articulated arm (12) of oblong shape is arranged on the upper portion of the housing (10) and is intended to close the opening (11) providing access to the water bowl (5). This articulated arm (12) is pivotally connected by one of its ends to the housing (10). Thus, the articulation of the arm (12) enables to close or to free the access to said bowl (5). The other end of the arm (12) is intended to removably cooperate with a cover (13).

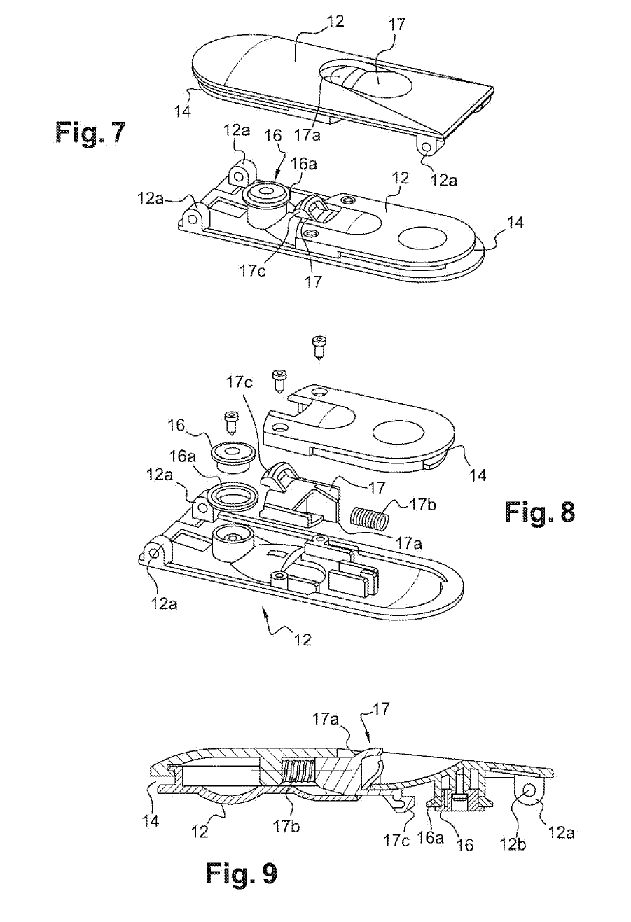

The articulated arm (12) is shown in further detail in FIGS. 7 to 9. It thus comprises, at a first end, two lateral flanges protruding (12a) downwards and intended to receive an axis (12b). The axis being connected to the housing, this enables to form a pin joint (12) on the housing (10).

The other end of the arm (12) comprises an arrangement of reception slot type (14), intended to receive a complementary arrangement (15) arranged on the cover (13) of the container (4). The cover (13) is thereby detachable from the arm (12).

A closing element (16) is located under the articulated arm (12), and has a shape complementary to the opening (11) of access to the bowl (5), and formed on the housing (10). This closing element (16) comprises a seal (16a) and, when the arm (12) is in closing position, tightly closes said opening (11).

Locking elements (17) are also arranged on the articulated arm (12). Such locking elements (17) are in the form of a trigger (17a), accessible from the top of the arm (12), and cooperating with a spring (17b). Said trigger (17a) comprises a tongue (17c) protruding from the bottom of the arm (12) and capable of engaging into a slot (18) provided on the housing (10). Thereby, when the trigger (17a) is actuated, the tongue (17c) conies out of the slot (18) and the arm (12) is then capable of passing to a non-closing position. The spring (17b) cooperating with the trigger (17a) enables to take it back to its original position. And when the arm (12) is in closing position, the tongue (17c) is engaged in said slot (18) and the locking is performed and maintained by the spring (17b) which maintains the trigger (17a), and accordingly the tongue (17c), in this position.

Given that the cover (13) is connected to the articulated arm (12), when this arm (12) switches from a closing position to a non-closing position, the bowl (5) and the container (4) are simultaneously open. Accordingly, when the arm (12) passes from the non-closing position to the closing position, the container is then closed by the cover (13).

The cover (13) appears in the form of a cylinder portion, complementary to the container (4) and is intended to close it. The cover (13) is provided on the lateral wall defining said cylinder with a through opening (13a) intended, when the container (4) is installed on the seat (2), to relatively tightly position in front of the outlet of a steam generator (3), to put the inside of the container (4) in communication with said steam generator (3).

During the use of the device (1), the container (4) is placed at the location intended for it, and the opening (13a) formed in the cover (13) is positioned in front of the duct (19) originating from the steam generator (3) by simple rotation, this rotation being limited in terms of angle, by a stop (not shown) formed in said cover (13), and complementarily cooperating with means integrated in the device frame, so that at the end of the rotation, said opening (13a) is properly positioned. Further, during this operation, the cover (13) exerts a pressure on a deformable seal, arranged at the level of the outlet area of the duct (19), to provide a tightness on transfer of the steam from the steam generator (3) to the container (4).

The respective arrangement of the steam inlet and outlet ports for a greater heating efficiency and a greater homogeneity is very advantageous, without for all this altering the simplicity of manufacturing and of use of such a device.

The arrangement of the articulated arm (12) then enables a user to simultaneously access: the bowl (5) for adding water necessary for the steam generation, and the container (4) and this, with one hand only, due to the simplified locking/unlocking system (17) equipping the articulated arm (12).

As appears from the foregoing description, this simplifies the use of device (1) of the present invention. Indeed, the bowl (5) of the steam generator (3) is accessed at the same time as the container (4).

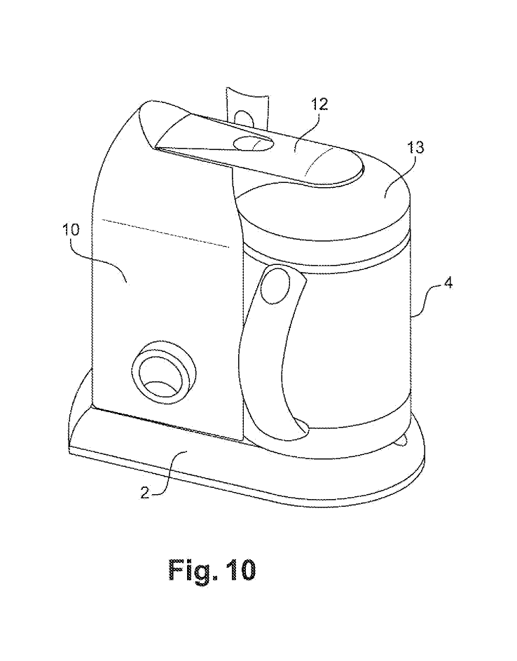

FIG. 10 shows a view of the device of the present invention in its “one-container” version. In this particular case, and conversely to the previously described embodiment, this device comprises a single container (4), closed by a cover (13) and an articulated arm (12). The container communicates, as in the previous case, with a steam generator (not shown).

It also receives a cooking basket.

This “one-container” mode device of course operates identically to that described in “two-container” mode.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1-7. (canceled)

8. A device for heating and/or cooking food, comprising:
a housing;
a steam generator received in the housing and having a steam generator body configured to receive water and converting the water into steam for heating and/or cooking the food;
a container in operative communication with the steam generator body;
a basket received by the container and configured to receive the food to be heated and/or cooked;
at least one closing mechanism configured to simultaneously and reversibly close the container and the steam generator body.

9. The device of claim 8, wherein the closing mechanism comprises:
a cover; and
an arm connected at a first end thereof to the cover and connected at a second end thereof to the housing for pivotal movement between a closed position to a non-closed position.

10. The device of claim 9, wherein in closed position, the container is closed by the cover and the steam generator body is simultaneously closed by the arm.

11. The device of claim 9, wherein the cover is removably attached to the arm.

12. The device of claim 8, wherein the container is provided with a through opening enabling the operative communication of the steam generator body with the inside of the container and the basket.

13. The device of claim 9, wherein the closing mechanism comprises:
elements configured to unlock and lock the closing mechanism it in closed position.

14. A device for heating and/or cooking food, comprising:
a housing;
steam generators configured to receive water and converting the water into steam for heating and/or cooking the food, the steam generators including a first steam generator received in the housing and having a first steam generator body and a second steam generator received in the housing and having a second steam generator body;
containers including a first container in operative communication with the first steam generator body and a second container in operative communication with the second steam generator body;
baskets configured to receive the food to be heated and/or cooked, the baskets including a first basket received by the first container and a second basket received by the second container; and
closing mechanisms including a first closing mechanism configured to simultaneously and reversibly close the first container and the first steam generator body, and a second closing mechanism configured to simultaneously and reversibly close the second container and the second steam generator body.

15. The device of claim 14, wherein the first closing mechanism comprises:
a first cover associated with the first steam generator body and first container; and
a first arm connected at a first end thereof to the first cover and connected at a second end thereof to the housing for pivotal movement between a closed position to a non-closed position.

16. The device of claim 15, wherein in closed position, the first container is closed by the first cover and the first steam generator body is simultaneously closed by the first arm.

17. The device of claim 15, wherein the first cover is removably attached to the first arm.

18. The device of claim 15, wherein the first closing mechanism comprises:
elements configured to unlock and lock the first closing mechanism it in closed position.

19. The device of claim 14, wherein the second closing mechanism comprises:
a second cover associated with the second steam generator body and second container; and
a second arm connected at a first end thereof to the second cover and connected at a second end thereof to the housing for pivotal movement between a closed position to a non-closed position.

20. The device of claim 19, wherein in closed position, the second container is closed by the second cover and the second steam generator body is simultaneously closed by the second arm.

21. The device of claim 19, wherein the second cover is removably attached to the second arm.

22. The device of claim 19, wherein the second closing mechanism comprises:
elements configured to unlock and lock the second closing mechanism it in closed position.

23. The device of claim 14, wherein:
the first closing mechanism comprises a first cover associated with the first steam generator body and first container, and a first arm connected at a first end thereof to the first cover and connected at a second end thereof to the housing for pivotal movement between a closed position to a non-closed position; and
the second closing mechanism comprises a second cover associated with the second steam generator body and second container, and a second arm connected at a first end thereof to the second cover and connected at a second end thereof to the housing for pivotal movement between a closed position to a non-closed position.

24. The device of claim 23, wherein in closed position:
the first container is closed by the first cover and the first steam generator body is simultaneously closed by the first arm; and
the second container is closed by the second cover and the second steam generator body is simultaneously closed by the second arm.

25. The device of claim 23, wherein:
the first cover is removably attached to the first arm; and
the second cover is removably attached to the second arm.

26. The device of claim 23, wherein the first closing mechanism comprises:
elements configured to unlock and lock the first closing mechanism it in closed position.

27. The device of claim 14, wherein:
the first container is provided with a through opening enabling the operative communication of the first steam generator body with the inside of the first container and the first basket; and
the second container is provided with a through opening enabling the operative communication of the second steam generator body with the inside of the second container and the second basket.
